(19) United States
(12) Patent Application Publication
(10) Pub. No.: US 2007/0257813 A1
(43) Pub. Date: Nov. 8, 2007

(54) Secure network bootstrap of devices in an automatic meter reading network

(75) Inventors: Raji Vaswani, Portola Valley, CA (US); James Pace, San Francisco, CA (US); Sterling Hughes, Oakland, CA (US); Jonathan Trostle, Ellicott City, MD (US)

Correspondence Address: Raj Abhyanker, LLP;c/o Intellevate, P.O. Box 52050, Minneapolis, MN, 55402, US

(73) Assignee: Silver Spring Networks

(21) Appl. No.: 11/701,745

(22) Filed: Feb. 2, 2007

Related U.S. Application Data
(60) Provisional application No. 60/765,054, filed on Feb. 3, 2006.

(51) Int. Cl. G08B 23/00

(52) U.S. Cl. 340/870.02

(57) ABSTRACT

A method and/or a system of a secure network bootstrap of devices in an automatic meter reading network is disclosed. A method of a network interface card in an automatic meter reading network includes generating a derived security key based on a secret key embedded in a network interface card and a provided security key of a device management server of the automatic meter reading network. The method also includes communicating the derived security key and a challenge data of a challenge-response pair of the device management server to a metering device and generating a response data through processing a reply data of the metering device reacting to the challenge data. In addition, the method includes communicating the response data to the device management server to authenticate the network interface card and/or the metering device.

### CLAIM OF PRIORITY

This application claims priority form provisional application 60/765,054 titled “method and system for secure network bootstrap” filed on Feb. 3, 2006

### FIELD OF TECHNOLOGY

This disclosure relates generally to the technical fields of software and/or hardware technology and, in one example embodiment, to system and method of a secure network bootstrap of devices in an automatic meter reading network.

### BACKGROUND

An automatic meter reading (AMR) may automatically collect data from a metering device (e.g., a water meter, a gas meter, an electricity meter, etc.) and/or transfer the data to a central database for billing and/or analyzing the data. The automatic meter reading may include handheld, mobile and/or network technologies based on telephony platforms (e.g., wired and wireless), radio frequency (RF), and/or powerline transmission, or dedicated, land-line connectivity such as the Ethernet.

The network technologies of the automatic meter reading (AMR) may be based on a network (e.g., having a plurality of metering devices) permanently installed to capture and/or transfer the data. The network may also include other devices (e.g., antennas, towers, collectors, repeaters, and/or other permanently installed infrastructure) to transfer (e.g., automatically) the data collected from a plurality of metering devices to the central database of a server (e.g., which oversees the metering devices and the other devices).

When the metering device and the other devices are first installed in the network, the metering device and the other devices need to be authenticated by the server. One or more authorized persons (e.g., employees and/or contractors of a company managing the network) may install a pluarality of metering devices and the other devices and/or perform an authentication of the of the installed metering devices and the other devices. However, allocating the authorized persons to perform the installation and personally authenticate each device, may incur an additional cost, and/or each of the authorized persons may have to follow security guidelines (e.g., set by the company).

Furthermore, the metering devices and the other devices of the network may be checked (e.g., periodically and/or intermittently) to determine a tampering (e.g., to affect a reading) of a plurality of the metering devices and the other devices using the one or more authorized persons, thus resulting in more extraneous costs. Tampering may include external intrusion into the metering device and the network interface firmware and software, installation of non-authorized components in the metering device and/or the network interface, tapping into one or more electrical and/or network connections in the device, breaking of the seal, and others. With a spending of the more extraneous costs, there may be no guarantee that the one or more authorized person abide (e.g., faithfully and/or strictly) by the guidelines set by the company.

### SUMMARY OF THE DISCLOSURE

A method and/or a system of a secure network bootstrap of devices in an automatic meter reading network is disclosed. In one aspect, a method of a network interface card (NIC) in an automatic meter reading (AMR) network includes generating a derived security key (e.g., which is an encryption key derived from a shared key based on a symmetric key cryptography) based on a secret key (e.g., which is a pseudorandom key embedded in a non-volatile memory of the network interface card) embedded in the network interface card (e.g., which is a separate card internally coupled to the metering device and/or a part of a circuit board of the metering device) and a provided security key of a device management server (DMS) of the automatic meter reading network.

The method also includes communicating the derived security key and a challenge data of a challenge-response pair of the device management server to a metering device and generating response data through processing reply data of the metering device reacting to the challenge data. In addition, the method includes communicating the response data to the device management server to authenticate the network interface card and/or the metering device.

The method may establish connectivity with the device management server (DMS) based on an internet protocol address (IPv4 or IPv6) and other attributes of the network interface card when the metering device having the network interface card is coupled to the device management server. The method may also include authenticating a connection between the network interface card and the metering device through matching a first password processed in the network interface card with a second password embedded in the metering device. In addition, the method may includes setting a secure network bootstrap bit of the network interface card to 1 and compressing encrypted data and firmware of the network interface card when a packet indicating a secure shutdown of the network interface card is processed in the network interface card. Moreover, the method may include setting a secure network bootstrap bit of the metering device to 1 and compressing encrypted data and firmware of the metering device when a packet indicating a secure shutdown of the metering device is processed in the metering device

In another aspect, a method of an automatic meter reading (AMR) network includes generating a database of a metering device having a network interface card through decrypting encrypted data (e.g., which includes descriptive device data, a password, an encryption key, the challenge response pair, and/or other device data) associated with the metering device. The method may also includes communicating the provided security key and challenge data of one or more challenge-response pair to the metering device to authenticate the metering device and determining any evidence of tampering of the metering device through analyzing a response data of the metering device.

The method may include installing a bootstrap code to the metering device such that a non-volatile memory of the metering device is readily accessible by the bootstrap code. The method may also include embedding the encrypted data and one or more challenge-response pairs to the metering device. In addition, the method may include delivering the encrypted data through a secure channel (e.g., which may include a trusted agency delivering an optical disk containing the encrypted data and/or a secure electronic messaging network communicating the encrypted data). Optionally, the method may further include communicating the provided security key and the challenge data using a device installation tool (DIT) carried by a trusted person by connecting the device installation tool to the metering device at a site of the metering device. Methods of physical connectivity of the DIT to the metering device are optional.

In yet another aspect, a system of an automatic meter reading (AMR) network includes an authentication module of a device management server (DMS) to generate a signal data to perform a secure bootstrapping of one or more metering devices and a secure bootstrap module in each of the one or more metering devices to generate response data to determine any tampering of the each of the one or more metering devices during the secure bootstrapping.

The system may include other devices (e.g., which include an access point, a relay, etc.) supporting a connectivity between the device management server and the one or more metering devices to perform the secure bootstrapping when the other devices are coupled to the device management server. The system may also include a device file (e.g., which includes a message authentication code, a device identifier, an encryption algorithm, a message authentication code algorithm identifier, an encrypted data size, an encrypted data, and/or other data) communicated to the device management server.

In addition, the system may include a timestamp byte embedded in the device file to prevent any tampering of the device file when the device file is communicated to the device management server through an untrusted channel. Moreover, the system may include a network interface card (e.g., non-volatile memory of the network interface card to include a secure network bootstrap bit, a decompression routine, a compressed minimal network and encryption algorithm routine, an initial network bootstrap code, a secret key, other firmware and data, and/or a pseudorandom bit sequence) having the secure bootstrap module to initiate the secure bootstrapping of the metering device through generating a derived security key based on the signal data.

The methods, systems, and devices disclosed herein may be implemented in any means for achieving various aspects, and may be executed in the form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example, and not limitation, in the figures of the accompanying drawings, in which like references indicate similar elements and in which:

FIG. 1 is a system diagram of an automatic meter reading (AMR) network having an authentication module to perform a secure bootstrapping of a plurality of metering devices, according to one embodiment.

FIG. 2 is a process flow chart of the manufacturing stage of a metering device having a network interface card, according to one embodiment.

FIG. 3 is an exploded view of a device file of FIG. 1, according to one embodiment.

FIG. 4 is an exploded view of encrypted data of FIG. 2, according to one embodiment.

FIG. 5 is a process flow chart of a device management server of FIG. 1 during an installation stage of the metering device of FIG. 1, according to one embodiment.

FIG. 6 is an exploded view of the metering device of FIG. 1, according to one embodiment.

FIG. 7 is an exploded view of a non-volatile memory of the network interface card of FIG. 6, according to one embodiment.

FIG. 8 is an exploded view of a non-volatile memory of the metering device of FIG. 6, according to one embodiment.

FIG. 9 is a process flow chart of a secure network bootstrapping of the network interface card and the metering device of FIG. 6, according to one embodiment.

FIG. 10 is a process flow chart of a secure shutdown of the network interface card and the metering device of FIG. 6, according to one embodiment.

Other features of the present embodiments will be apparent from the accompanying drawings and from the detailed description that follows.

### DETAILED DESCRIPTION

A system and method is disclosed for providing a network bootstrap technique for the secure installation, activation/authentication and reactivation/reauthentication of a networked device (for example, the utility meter and the network interface cards, and DA devices). In the following description, for the purposes of explanation, numerous specific details are set forth in order to provide a thorough understanding of the various embodiments. It will be evident, however to one skilled in the art that the various embodiments may be practiced without these specific details.

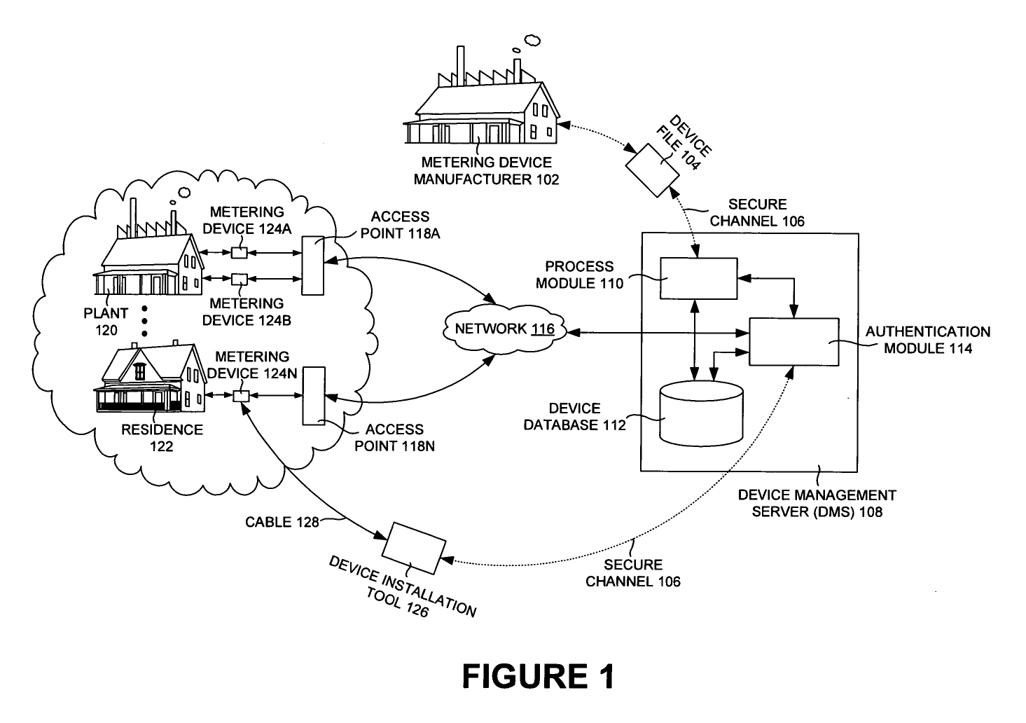

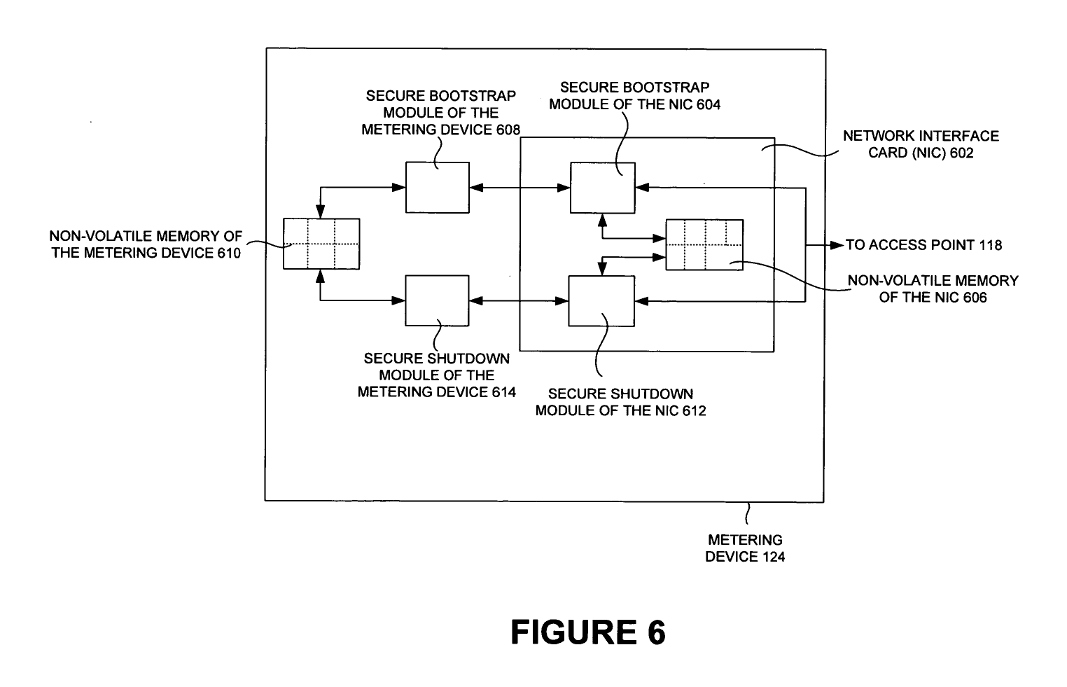

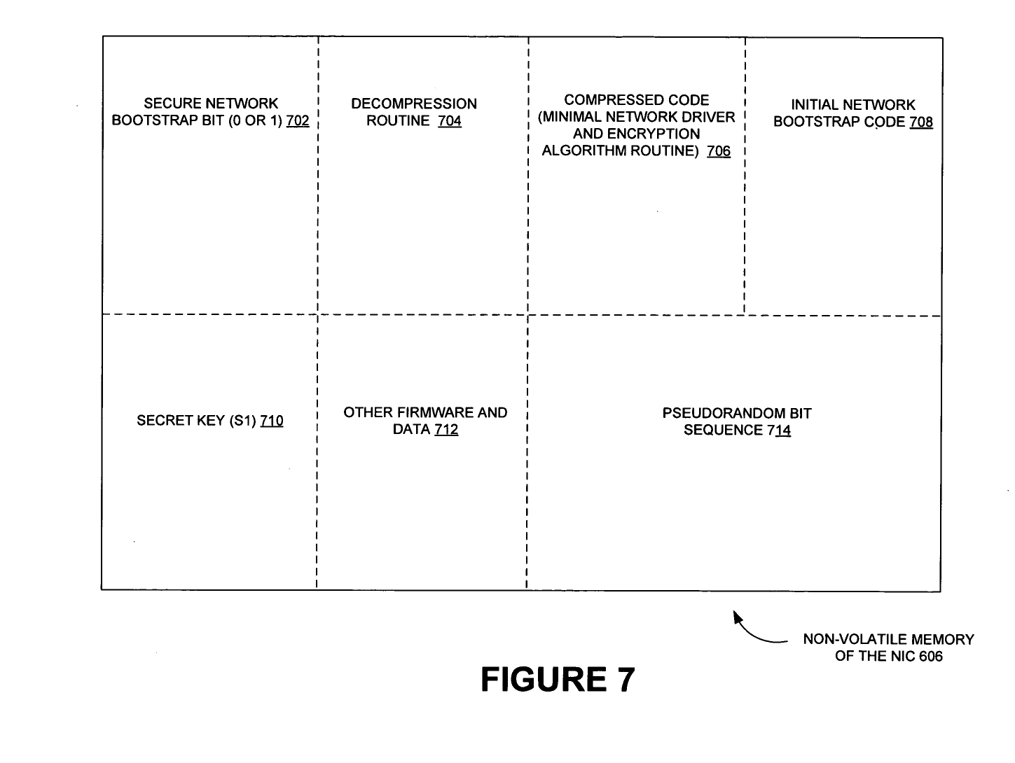

In one embodiment, a method of a network interface card (NIC) in an automatic meter reading (AMR) network (e.g. of FIG. 1) includes generating a derived security key based on a secret key (e.g., a secret key 710 of FIG. 7) embedded in the network interface card (e.g., a network interface card 602 of FIG. 6) and a provided security key of a device management server (e.g., a device management server 108 of FIG. 1) of the automatic meter reading network.

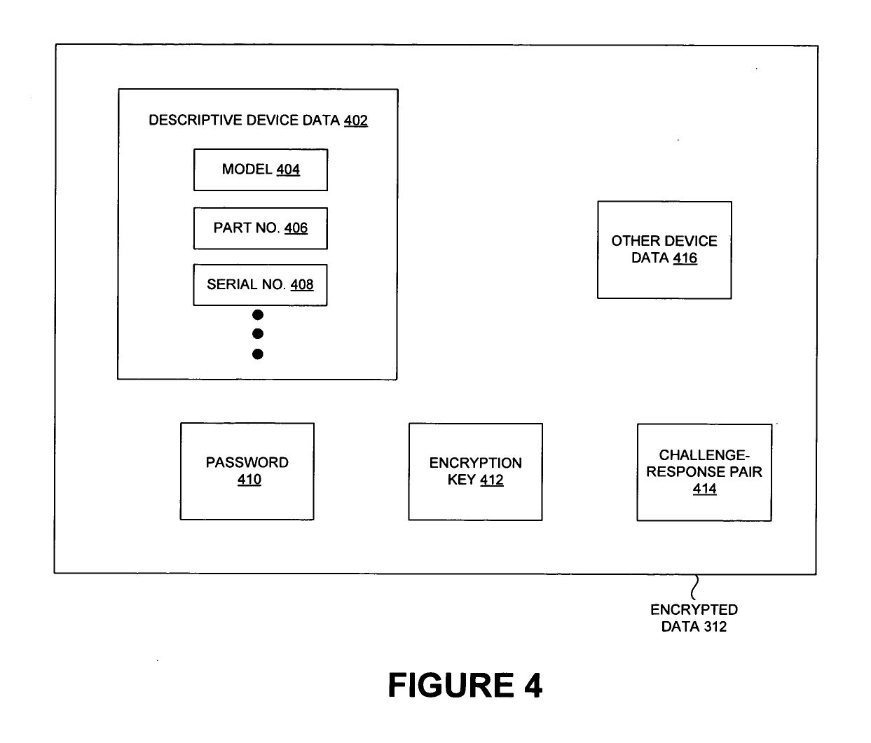

The method also includes sending the derived security key (which may be sent over a secure communication channel, or may be encrypted) and challenge data of a challenge-response pair (e.g., a challenge-response pair 414 of FIG. 4) of the device management server in a secure mode to any one of the NICs and metering devices and generating response data through processing reply data of the metering device reacting to the challenge data. In addition, the method includes communicating the response data to the device management server to authenticate the network interface card and/or the metering device.

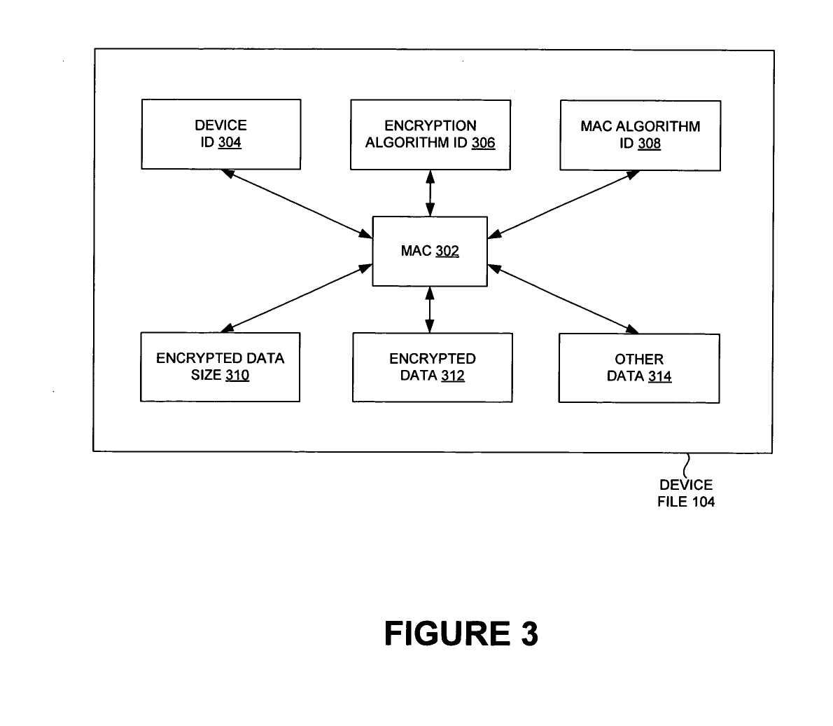

In another embodiment, a method of an automatic meter reading (AMR) network includes generating a database (e.g., a device database 112 of FIG. 1) of a metering device having a network interface card through decrypting encrypted data (e.g., encrypted data 312 of FIG. 3) associated with the metering device. The method also includes communicating a provided security key and challenge data of one or more challenge-response pair(s) to the metering device to authenticate the metering device and determining any tampering of the metering device through analyzing the response data of the metering device.

In yet another embodiment, a system of an automatic meter reading (AMR) network includes an authentication module (e.g., an authentication module 114 of FIG. 1) of a device management server (DMS) to generate a signal data to perform a secure bootstrapping of one or more metering devices and a secure bootstrap module in each of the one or more metering devices to generate response data determining any tampering of each of the one or more metering devices during the secure bootstrapping.

FIG. 1 is a system diagram of an automatic meter reading (AMR) network having an authentication module 114 to perform a secure bootstrapping of a number of metering devices 124, according to one embodiment. As illustrated in FIG. 1, the system includes a metering device manufacturer 102, a device file 104, a secure channel 106, a device management server (DMS) 108, a process module 110, a device database 112, an authentication module 114, a network 116, an access point 118, a plant 120, a residence 122, a metering device 124, a device installation tool 126, and/or a cable 128. The metering device manufacturer 102 may generate the device file 104 associated with the metering device 124 and/or place an encrypted equivalent of the device file 104 to the metering device 124.

The device file 104 may be encrypted by the manufacturer using a key derived from a shared key (e.g., either symmetric or public key-pair using a public-key cryptography standards (PKCS) envelope standard) that may be pre-shared between the metering device manufacturer 102 and a customer (e.g., a utility company) of the metering device manufacturer 102. According to one embodiment, the device file 104 may be encrypted with a symmetric block cipher such as an advanced encryption standard cipher block chaining (AES-CBC) with 128 block size and a 128 bit or 256 bit key (e.g., where a shared symmetric key may be either preconfigured between the metering device manufacturer 102 and the customer, and/or the device file 104 may be encrypted in a public key of the customer).

The secure channel 106 may be used to communicate the device file 104 to the device management server (DMS) 108. The device management server 108 may be a server computer on the automatic meter reading network dedicated to running software applications. The process module 110 may generate a database of the metering device 124 (e.g., through decrypting the device file 104). The device database 112 may contain information of the metering device 124 of the automatic meter reading network. The authentication module 114 may verify the metering device 124 when the metering device 124 is first installed to the automatic meter reading network and/or check any tampering of the metering device 124 (e.g., and/or the network interface card 602 of FIG. 6 associated with the metering device 124).

The network 116 may be a network operating system in client and server machine, cables connecting them, and all supporting hardware in between the client and server machines, such as bridges, routers and/or switches. The access point 118 may be a device that connects wireless communication devices (e.g., a relay, the metering device 124, etc.) to the network 116 (e.g., the wide area network, a cellular network, an Internet, etc.). The plant 120 and/or the residence 122 may subscribe to a service provided by the automatic meter reading network. The metering device 124 may gauge a consumption of a utility item (e.g., a gas, an electricity, a water, etc.). The device installation tool 126 may be used by an agent authorized by the automatic meter reading network to perform a secure network bootstrapping of the metering device 124.

For example, a bootstrap code may be embedded to the metering device 124 (e.g., by the metering device manufacturer 102) such that a non-volatile memory (e.g., the non-volatile memory of the metering device 610 of FIG. 6) of the metering device 124 is readily accessible by the bootstrap code. The encrypted data 312 of the device file 104 may be delivered to generate the device database 112 through the secure channel 106 (e.g., which includes a trusted agency delivering an optical disk containing the encrypted data and/or a secure electronic messaging network communicating the encrypted data). Trusted channel can be an agent, physical device, network means, and other forms known to both the parties involved in exchange of the secure information, and is trusted by both parties to preserve the secrecy and accuracy of the information known only to the parties involved in exchanging such information.

A timestamp byte embedded in the device file 104 may be used to prevent a tampering of the device file 104 when the device file 104 is communicated to the device management server 108 through an untrusted channel. This may involve protection against insertion of intruder's data files in the NIC and the metering device subsequent to the initial embedding process during manufacturing. The authentication module 114 of the device management server (DMS) 108 may generate a signal data (e.g., which may be an encryption key derived from a shared key based on a symmetric key cryptography and/or a pseudorandom key embedded in a non-volatile memory of the network interface card 602) to perform a secure bootstrapping of one or more of the metering device 124. A network connectivity may be established with the device management server 108 based on an internet protocol address (IPv4 or IPv6) and other attributes of the network interface card 602 of FIG. 6 when the metering device 124 having the network interface card 602 is coupled to the device management server 108.

The metering device 124 and/or other devices (e.g., an access point, a relay, etc.) supporting the connectivity between the device management server 108 and the plurality of metering device 124 may perform a secure bootstrapping when the metering device 124 and/or the other devices are coupled to the device management server 108. A provided security key and a challenge data may be communicated using the device installation tool (DIT) 126 carried by a trusted person through connecting the device installation tool 126 to the metering device at a site of the metering device 124 using the cable 128 (e.g., serial and/or parallel).

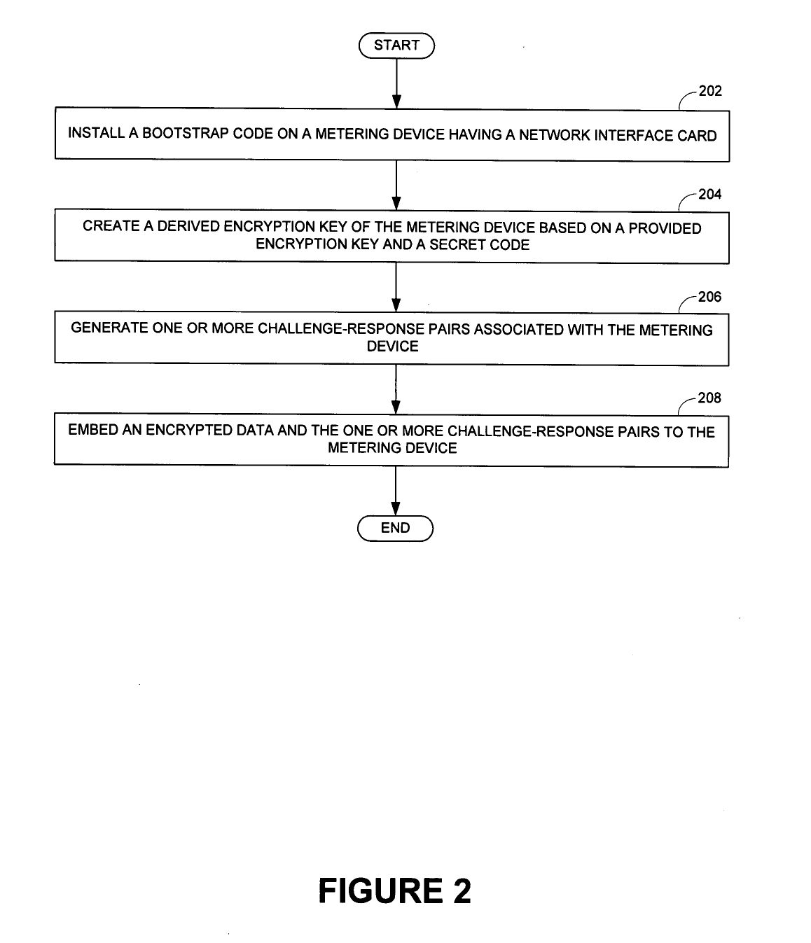

FIG. 2 is a process flow chart of a manufacturing stage of a metering device having a network interface card, according to one embodiment. In operation 202, a bootstrap code may be installed on the metering device 124 having the network interface card 602. In operation 204, a derived encryption key of the metering device 124 may be created based on a provided encryption key and a secret code (e.g., pseudorandom). In operation 206, one or more challenge-response pair 414 of FIG. 4 associated with the metering device 124 may be generated. In operation 208, the encrypted data 312 of FIG. 3 and the one or more challenge-response pair 414 may be embedded to the metering device 124.

FIG. 3 is an exploded view of the device file 104, according to one embodiment. As illustrated in FIG. 3, the device file 104 may contain a message authentication code 302, a device ID 304, an encryption algorithm ID 306, a MAC algorithm ID 308, an encrypted data size 310, an encrypted data 312, and other data 314. The message authentication code 302 may be a keyed hashing for message authentication code (HMAC)-secure hash algorithm (SHA) 256 using a shared symmetric key between the metering device manufacturer 102 and the customer. The device ID 304 may be a MAC address or other device identifier. The encryption algorithm ID 306 may be 2 bytes long indicating a symmetric encryption algorithm of the device file 104.

The MAC algorithm ID 308 may be 2 bytes long identifying an algorithm of the message identification code. The encrypted data size 310 may be a size of the encrypted data 312 in bytes.

FIG. 4 is an exploded view of encrypted data of FIG. 2, according to one embodiment. As illustrated in FIG. 4, the encrypted data 312 includes a description device data 402, a password 410, an encryption key 412, and/or a challenge response pair 414. The description device data 402 includes a model 404 of the metering device 124, a part number 406 of the metering device 124, and/or a serial number 408 of the metering device 124. The password 410 may be used by the network interface card 602 of FIG. 6 to log onto the metering device 124 of FIG. 1 to authenticate a connection between the network interface card 602 and the metering device 124.

The encryption key 412 (K) may be derived as K=E(K1, S1) where E may be the symmetric encryption algorithm of the metering device 124 and SI may be a pseudorandom secret. One or more of the challenge-response pair (e.g., which may be pseudorandom HMAC keys) may be computed by the metering device manufacturer 102. The list of challenge-response pair(s) may be denoted as: (challenge_d1, device_response 1), (challenge_dn, device_response_n) then device response_i=HMAC (challenge_i, contents of non-volatile memory on device) as well as response_i=HMAC (challenge_i, device_response_i|contents of non-volatile memory on the network interface card) where “|” denotes a concatenation.

The encrypted data 312 may be obtained through installing a bootstrap code on both the metering device 124 (e.g., and/or other devices associated with the automatic meter reading network) and the network interface card 602 that may access a non-volatile memory during a bootstrap procedure.

An example format of the encrypted data 312 may be described as |device file data|padding length (0-7 bytes)|padding byes each containing padding length|. An example encryption key may be generated based on the following formula: the encryption key=E (a shared key, a device ID|plus enough of the following string to obtain 128 bytes (e.g., 0x6AA4872309821095BBBBBBAABBBBCCAA) and an integrity key=E (the shared key, the device ID|plus enough of the following byte string to obtain 128 bytes: 0x99C7610837790221AAAAAAAAABBBBCCA) where a symmetric cipher operating on a 128 bit block is assumed.

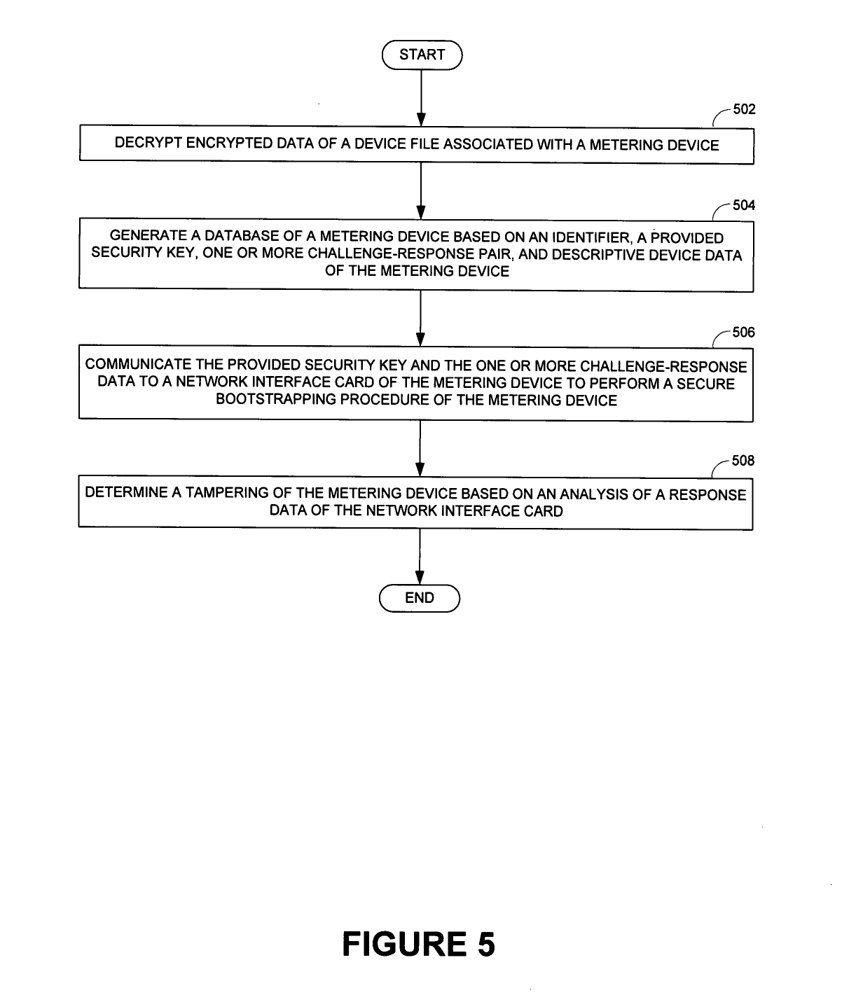

FIG. 5 is a process flow chart of a device management server of FIG. 1 during an installation stage of the metering device of FIG. 1, according to one embodiment. In operation 502, the encrypted data 312 of FIG. 3 of the device file 104 associated with the metering device 124 may be decrypted. In operation 504, the device database 112 of the metering device 124 may be generated based on the descriptive device data 402 of FIG. 4, the password 410, the encryption key 412, the challenge-response pair 414, and the other data 416 of the metering device 124. In operation 506, the encryption key (e.g., a provided security key) and one or more of the challenge-response pair 414 may be communicated to the network interface card 602 of FIG. 6 of the metering device 124 to perform a secure bootstrapping procedure of the metering device 124. Any tampering of the metering device 124 may be determined in operation 508 based on an analysis of a response data of the network interface card 602.

For example, the device database 112 of the metering device 124 having the network interface card 602 may be generated through decrypting the encrypted data 312 associated with the metering device 124. A provided security key and a challenge data of at least one of the challenge-response pair 414 may be communicated to the metering device 124 to authenticate the metering device 124. Any tampering of the metering device 124 may be determined through analyzing a response data of the metering device 124.

FIG. 6 is an exploded view of the metering device 124 of FIG. 1, according to one embodiment. As illustrated in FIG. 6, the metering device 124 of FIG. 1 includes the network interface card 602, a secure bootstrap module of the network interface card 604, a non-volatile memory of the network interface card 606, a secure bootstrap module of the metering device 608, a non-volatile memory of the metering device 610, a secure shutdown module of the network interface card 612, and/or a secure shutdown module of the metering device 614. The network interface card 602 may be part of computer network hardware designed to allow computers to communicate over a computer network (e.g., the automatic meter reading network of FIG. 1).

The secure bootstrap module of the network interface card 604 and the secure bootstrap module of the metering device 608 may be used to authenticate and/or check a tampering of the metering device 124.

FIG. 7 is an exploded view of the non-volatile memory of the network interface card 606 of FIG. 6, according to one embodiment. As illustrated in FIG. 7, the non-volatile memory of the network interface card 606 includes a secure network bootstrap bit 702, a decompression routine 704, a compressed code of minimal network driver and encryption algorithm routine 706, an initial network bootstrap code 708, a secret key 710, other firmware and data 712, and/or a pseudorandom bit sequence 714. The secure network bootstrap bit 702 may be a single bit (e.g. 0 or 1) indicating whether a secure network bootstrap is taking place or not (e.g., in the network interface card 602). The decompression routine 704 may be a process to decompress the compressed code.

The minimal network driver of the compressed code 706 may be sufficient to receive the challenge-response pair 414 of FIG. 4 and a provided security key (e.g., of the device management server 108 and/or the device installation tool 126 of FIG. 1). (The NIC receives the challenge and generates the response; it may also receive a challenge response pair and then send the challenge to the meter and receive a response back from the meter. In otherwords, when the NIC is challenged, it must generate its own response, but if the NIC challenges the meter, then the NIC could have the response (sent to it in challenge response pair or embedded) to compare against the meter response). The initial network bootstrap code 708 and the secret key 710 (e.g., pseudorandom) may be embedded in the metering device 124 by the metering device manufacturer 102 (e.g., during a manufacturing stage of the metering device 124). The other firmware and data 712 may be encrypted with a symmetric encryption algorithm based on an encryption key (K) derived from a provided key. The pseudorandom bit sequence 714 may be used to fill a remaining memory space of the non-volatile memory of the network interface card 606.

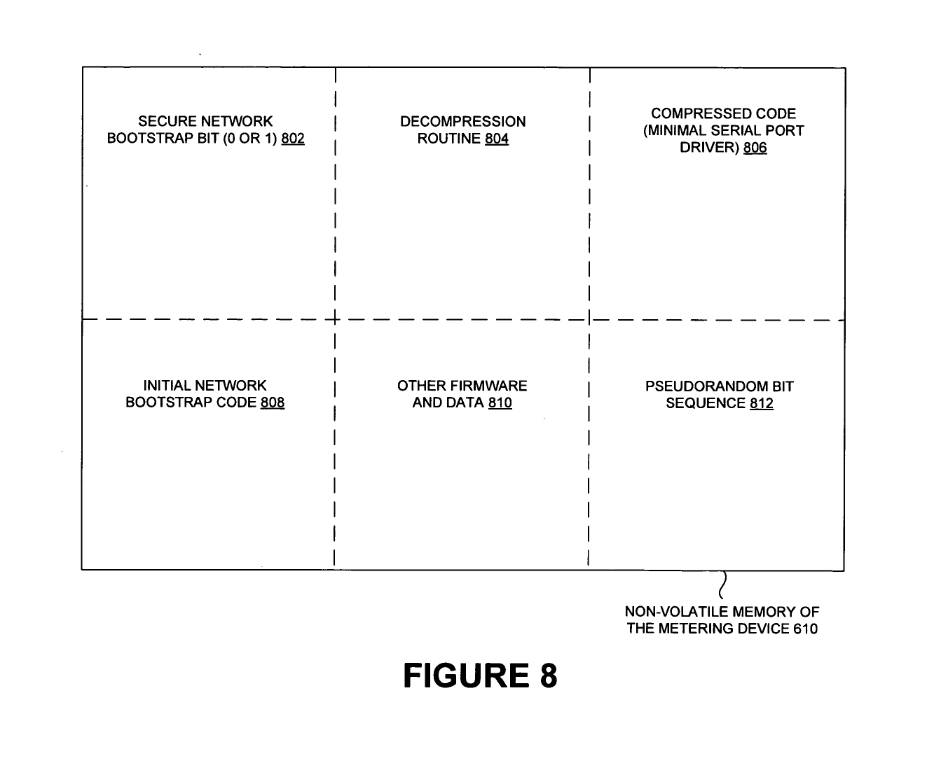

FIG. 8 is an exploded view of a non-volatile memory of the metering device 610 of FIG. 6, according to one embodiment. As illustrated in FIG. 8, the non-volatile memory of the metering device 610 includes a secure network bootstrap bit 802, a decompression routine 804, a compressed code of minimal serial port driver 806, an initial network bootstrap code 808, other firmware and data 810, and/or a pseudorandom bit sequence 812. The secure network bootstrap bit 802 may be a single bit (e.g. 0 or 1) indicating whether a secure network bootstrap is taking place or not (e.g., in the metering device 124). The decompression routine 804 may be a process to decompress the compressed code.

In one example embodiment encompassing the secure bootstrap module of the network interface card 604 and the secure bootstrap module of the metering device 608, upon a network bootstrap of the network interface card 602, the initial secure network bootstrap code may run and/or inspect the secure bootstrap bit. If the bit is set to 1, then the secure bootstrap may occur. The initial network bootstrap code 708 may decompress the compressed code 706. The minimal network driver code of the compressed code 706 may be sufficient to receive the challenge-response pair 414 and a provided security key from the device installation tool 126 and/or the authentication module 114 of the device management server 108. The internet protocol layer may not be required, so a Layer 2 header followed by data (e.g., including the challenge-response pair 414 and the provided security key) may be utilized, particularly if the Device Installation Tool (DIT) is managing the authentication and bootstrap process. Also, the minimal network driver code may be needed to receive only, but not to send.

An AES encryption routine (e.g., and/or a comparable encryption routine) may then be used with the secret key 710 and the provided security key to obtain a derived security key. The first block of the encrypted code (and possibly some succeeding blocks if needed) is decrypted. The contents of the Device File are now available, including Device password(s). The network interface card 602 may log onto the metering device 124 (e.g., if required) and/or pass a password to authenticate a connection. First, the secure network bootstrap bit 802 of the metering device 124 may be checked and/or authenticated. Then, the secure network bootstrap bit 802 of the metering device 124 may decompress the compressed code and/or receive data over a serial link (e.g., and/or other interface).

The network interface card 602 may request each HMAC block of code from the metering device 124 and update a HMAC value for the metering device 124. The network interface card 602 may also decrypt each encryption block of symmetric encryption algorithm and send a decrypted code back to the metering device 124. The last block may be smaller than a block length of the symmetric encryption algorithm (e.g., which may not encrypted), but the last block may still be used to update the HMAC value. When the process is completed, encrypted code block of the metering device 124 may then be decrypted, and/or the secure network bootstrap routine of the network interface card 602 may calculate a response value of the metering device 124. The last value may be an input into the HMAC calculation over the code of the network interface card 602.

The network interface card 602 may compute the response value using the volatile memory of the network interface card 606. The network interface card 602 may compute the HMAC response value given the device response value and a challenge value of the network interface card 602. After computing the final response value, additional code may be decrypted. The response value may be sent to device installation tool 126 and/or the authentication module 114, depending on how the network is configured. The device installation tool 126 and/or the authentication module 114 of the device management server 108 may compare the response value received from the network interface card 602 and/or the metering device 124 with a response value stored in the device installation tool 126 and/or the authentication module 114.

If the response value matches, then the device management server 108 may determines that the metering device 124 is authentic and/or is free from any tampering, thus authorizing the metering device 124 an access to the automatic meter reading network associated with the device management server 108. Then, the network interface card 602 and the secure network bootstrap bit of network interface card and the secure network bootstrap bit of the metering device may be reset to 0. All of the data and firmware on both the metering device 124 and the network interface card 602 may be decrypted. Additionally, it may possible to load additional data onto the metering device 124 and/or to the network interface card 602 at this point (e.g., overwriting the pseudorandom bit sequence 714 and/or the pseudorandom bit sequence 812).

The minimal serial port driver 806 may be sufficient to receive a challenge data of the network interface card 602 associated with the challenge-response pair 414 of FIG. 4 and a derived security key (e.g., of the network interface card 602). The initial network bootstrap code 808 may be embedded in the metering device 124 by the metering device manufacturer 102 (e.g., during a manufacturing stage of the metering device 124). The other firmware and data may be encrypted with a symmetric encryption algorithm based on the derived key of the network interface card 602. The pseudorandom bit sequence 812 may be used to fill a remaining memory space of the non-volatile memory of the network interface card 602.

The secure shutdown module of the network interface card 602 and the secure shutdown module of the metering device 124 may oversee a secure shutdown process when a next secure bootstrapping of the network interface card 602 and/or the metering device 124 is to be performed in a secure mode. In another example embodiment, the secure shutdown process may be on a planned schedule basis, or may happen due to a power failure and/or other internally and/or externally induced conditions. A pair of pseudorandom secrets and a provided security key may be sent from the device management server 108 to the metering device 124 in a packet indicating that a secure shutdown procedure should take place (e.g., over a trusted network).

The provided security key and the pseudorandom secrets may be used to generate a derived key. The secure shutdown procedure may include setting the secure network bootstrap bit to 1, encrypting the network interface card data and firmware, possibly compressing some encrypted file, and/or possibly writing a pseudorandom bit sequence. The network interface card 602 may communicates a secure shutdown procedure message over a serial link (e.g., and/or other interface) to the metering device 124, and a secure shutdown procedure similar to what happened to the network interface card 602 may occur on the metering device 124.

At shutdown (e.g., due to a power failure, a removal of the metering device 124 and/or other devices) the network firmware may set the secure bootstrap bit. The decrypted code block may be encrypted, and/or the provided security key may be deleted.

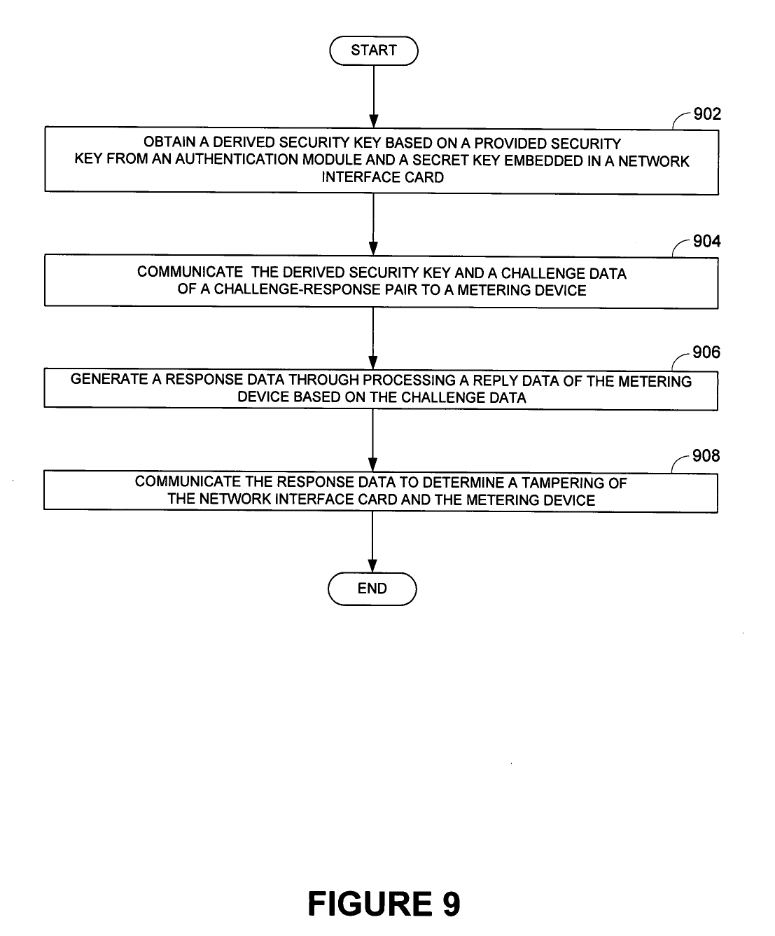

FIG. 9 is a process flow chart of a secure network bootstrapping of the network interface card 602 and the metering device 124 of FIG. 6, according to one embodiment. In operation 902, a derived security key may be obtained based on a provided security key from the authentication module 114 and the secret key 710 embedded in the network interface card 602. In operation 904, the derived security key and a challenge data of the challenge-response pair 414 of FIG. 4 may be communicated to the metering device 124. In operation 906, a response data may be generated through processing a reply data of the metering device 124 based on the challenge data. In operation 908, the response data may be communicated to determine any tampering of the network interface card 602 and the metering device 124.

In one example embodiment, a derived security key may be generated based on the secret key 710 of FIG. 7 embedded in the network interface card 612 of FIG. 6 (e.g., which is a separate card internally coupled to the metering device and/or a part of a circuit board of the metering device) and a provided security key of the device management server 108 of FIG. 1 of the automatic meter reading network. The derived security key and a challenge data of the challenge-response pair 414 of FIG. 4 of the device management server 108 may be communicated to the metering device 124. A response data may be generated through processing a reply data of the metering device 124 reacting to the challenge data. The response data may be communicated to the device management server 108 to authenticate the network interface card 602 and/or the metering device 124.

A connection between the network interface card 602 and the metering device 124 may be authenticated through matching a first password processed in the network interface card 602 with a second password embedded in the metering device 124. The network interface card 602 having the secure bootstrap module of network interface card 604 may initiate a secure bootstrapping of the metering device 124 through generating a derived security key based on a signal data of the device management server 108.

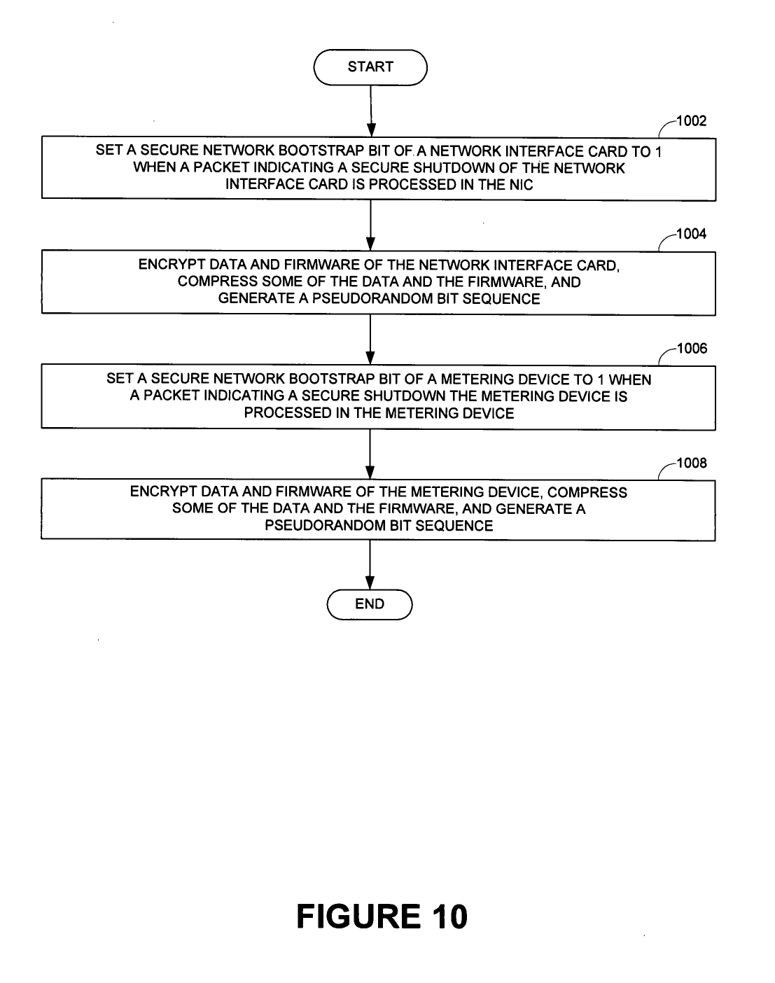

FIG. 10 is a process flow chart of a secure shutdown of the network interface card and the metering device of FIG. 6, according to one embodiment. In operation 1002, the secure network bootstrap bit of the network interface card may be set to a predetermined value, such as 1, when a packet indicating a secure shutdown of the network interface card 602 is processed in the network interface card 602. In operation 1004, data and firmware of the network interface card 602 may be encrypted, some of the data and the firmware may be compressed, and/or a pseudorandom bit sequence may be generated. In operation 1006, the secure network bootstrap bit of the metering device may be set to 1 when a packet indicating a secure shutdown of the metering device 124 is processed in the metering device 124. In operation 1008, data and firmware of the metering device 124 may be encrypted, some of the data and the firmware may be compressed, and/or a pseudorandom bit sequence may be generated.

In one example embodiment, the secure network bootstrap bit of the network interface card may be set to 1 and/or encrypted data and firmware of the network interface card 602 may be compressed when a packet indicating a secure shutdown of the network interface card 602 is processed in the network interface card 602. A secure network bootstrap bit of the metering device may be set to 1 and/or encrypted data and firmware of the metering device 124 may be compressed when a packet indicating a secure shutdown of the metering device 124 is processed in the metering device 124.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium).

For example, the process module 110 and/or the authentication module 114 of FIG. 1, and/or the secure bootstrap module of the network interface card 604, the secure bootstrap module of the metering device 608, the secure shutdown module of the network interface card 612, and/or the secure shutdown module of the metering device 614 of FIG. 6 may be embodied through a process circuit, an authentication circuit, a secure bootstrap circuit of the network interface card, a secure bootstrap circuit of the metering device, a secure shutdown circuit of the network interface card, and/or a secure shutdown circuit of the metering device using one or more of the technologies described herein.

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. A method of a provisioning an electronic device in an automatic meter reading network, comprising:
generating a derived security key and a challenge data of a challenge-response pair of the device management server, the derived security key based on a secret key embedded in the electronic device and the provided security key of a device management server of the automatic meter reading network;
generating a response data through processing a reply data of the metering device reacting to the challenge data; and
communicating the response data to the device management server to authenticate the electronic device.

2. The method of claim 1, further comprising establishing a data link layer and network-layer connectivity with the device management server based on an internet protocol address and other attributes of a network interface card included in the electronic device when the electronic device having the network interface card is coupled to the device management server.

3. The method of claim 2, wherein the derived key is an encryption key derived from a shared key based on a symmetric key cryptography and the secret key is a pseudorandom key embedded in a non-volatile memory of the network interface card.

4. The method of claim 3, wherein the network interface card is at least one of a separate card internally coupled to the electronic device and a part of a circuit board of the electronic device for performing metering.

5. The method of claim 4, further comprising authenticating a connection between the network interface card and the metering device through matching a first password processed in the network interface card with a second password embedded in the metering device.

6. The method of claim 5, further comprising setting a secure network bootstrap bit of the network interface card to a predetermined value and decompressing encrypted data and firmware of the network interface card when a packet indicating a secure shutdown of the network interface card is processed in the network interface card.

7. The method of claim 6, further comprising setting a secure network bootstrap bit of the metering device to predetermined value and decompressing encrypted data and firmware of the metering device when a packet indicating a secure shutdown of the metering device is processed in the metering device.

8. The method of claim 1 in a form of a machine-readable medium embodying a set of instructions that, when executed by a machine, causes the machine to perform the method of claim 1.

9. A method of an automatic meter reading (AMR) network, comprising:
communicating a provided security key and a challenge data of at least one challenge-response pair to the metering device to authenticate the metering device; and
determining any tampering of the metering device through analyzing a response data of the metering device.

10. The method of claim 9, wherein the encrypted data to include at least one of a descriptive device data, a password, an encryption key, the challenge response pair, and other device data.

11. The method of claim 10, further comprising installing a bootstrap code to the metering device such that a non-volatile memory of the metering device is readily accessible by the bootstrap code.

12. The method of claim 11, further comprising embedding the encrypted data and the at least one challenge-response pair to the metering device.

13. The method of claim 12, further comprising delivering the encrypted data to perform the generating the database through a secure channel, wherein the secure channel to include at least one of a trusted agency delivering an optical disk containing the encrypted data and a secure electronic messaging network communicating the encrypted data.

14. The method of claim 13, further comprising performing the communicating the provided security key and the challenge data using a device installation tool (DIT) carried by a trusted person through connecting the device installation tool to the metering device at a site of the metering device.

15. An electronic meter for use in a utility meter network; comprising:
a commodity meter capable of metering at least one commodity;
a network interface card capable of interfacing with a communications network, the network interface card communicatively coupled to the commodity meter; memory for storing a secret key of a secret key pair; and
a processor capable of processing requests to generate a security key, wherein the processor generates a derived security key, the derived security key based on a secret key of the secret key pair and a provided security key, and wherein the network interface card sends the derived security key to a device management server over a communications network.

16. The utility meter of claim 15, wherein the processor capable of processing requests to generate a security key is included on the network interface card.

17. The utility meter of claim 15, wherein the memory of the utility meter includes a secure network bootstrap bit.

18. The utility meter of claim 16, wherein the processor network interface card prevents the sending of meter information in the event the secure network bootstrap bit is not set to a predetermined value.

19. The utility meter of claim 16, wherein the network interface card puts the utility meter in a secure shutdown state in response to receiving a predetermined secure shutdown message, wherein the secure shutdown state prevents the utility meter from sending utility meter information.

20. The utility meter of claim 15, wherein the memory includes an authenticating password, wherein the processor generates response data using the authenticating password and wherein the network interface card sends the response data to a device management server over a communications network.

21. The utility meter of claim 15, wherein network interface card sends the response data to a device management server over a communications network, the response data including information accessed from memory uniquely identifying the commodity meter.

22. A method of provisioning a network interface card associated with a utility meter for use in a utility network, comprising:
embedding a symmetric key in a memory device of the network interface card for use in a utility network;
embedding a device data file in the memory device of the network interface card for use in a utility network;
recording the embedding of the symmetric key and device data file for later transmission to a device management server, wherein transmission of the embedding of the symmetric key and device data file for later transmission to a device management server allows for authentication of the network interface card;
A procedure and format for generating Device Ship files along with symmetric key to be shared between the manufacturer and the customer;
A procedure and format for conducting Device installation in the field with the help of a device management System and a device Installation tool;
A procedure and format for executing secure network bootstrap of the metering device and the NIC (referred to as the “Device”);
A procedure and format for executing secure shutdown prepare commit, for cases wherein the device has to reboot due to planned or accidental shutdowns after incidents of tampering, etc., so that the device is reauthenticated and reinstalled before it reenters the network in a secure manner; and
A procedure to protect the device against tampering, where tampering may involve any of the following but not limited to them: (a) electronic and/or physical alterations of the metering device by unauthorized electronic means; (b) insertion of the non-approved physical or electronic components in the metering device; (c) alteration of data measured and/or stored in the metering device; (d) unauthorized external tapping/connection into the data sources in the metering device.
